(19) United States
(12) Patent Application Publication
(10) Pub. No.: US 2015/0002342 A1
(43) Pub. Date: Jan. 1, 2015

(54) VEHICLE ANTENNA FOR MOBILE SERVICES

(71) Applicant: Hyundai Motor Company, Seoul (KR)

(72) Inventors: Tae Inn Chung, Gwangju (KR); Tae-Hwan Yoo, Incheon (KR)

(73) Assignee: HYUNDAI MOTOR COMPANY, Seoul (KR)

(21) Appl. No.: 14/085,172

(22) Filed: Nov. 20, 2013

(30) Foreign Application Priority Data
Jul. 1, 2013 (KR) 10-2013-0076573

(51) Int. Cl. H01Q 1/27

(52) U.S. Cl. CPC H01Q 1/27
USPC 343/702

(57) ABSTRACT

A pole-type vehicle antenna is provided that is mounted to a vehicle for the purpose of mobile services. In the vehicle antenna, a new type antenna for mobile services that substitutes for an antenna pole in a breakdown of the antenna pole is implemented by providing a thin film type preliminary antenna that performs antenna functions for mobile services inside an antenna case. Therefore, when the antenna is broken, a driver does not feel inconvenient in using mobile services.

### CROSS-REFERENCE TO RELATED APPLICATION

This application claims under 35 U.S.C. §119(a) the benefit of Korean Patent Application No. 10-2013-0076573 filed Jul. 1, 2013, the entire contents of which are incorporated herein by reference.

### BACKGROUND

(a) Technical Field

The present invention relates to a vehicle antenna for mobile services. More particularly, the present invention relates to a pole-type antenna mounted to a vehicle for the purpose of mobile services.

(b) Background Art

As communication devices are developed, several antennas that receive frequencies of an FM/AM radio, digital multimedia broadcasting (DMB) frequencies, frequencies of a remote keyless entry (RKE) system, etc. are being mounted within a vehicle and extraneous to a vehicle. For example, an antenna that receives FM/AM radio frequencies, an antenna that receives DMB frequencies, an antenna that receives RKE frequencies, and the like are frequently mounted to a vehicle.

In particular, the antenna that receives FM/AM radio frequencies is of a pole type in which a flexible pipe may be controlled vertically. The antenna that receives DMB frequencies is of a monopole type having a ¼ wavelength. The antenna that receives RKE frequencies is mounted within a vehicle to receive an RKE signal from an external transmitter within a particular radius. Recently, an integrated antenna has been proposed in which a global positioning system (GPS) antenna, a code division multiple access (CDMA) antenna and a helical antenna that receive radio frequencies and DMB frequencies is mounted within a shark-fin-shaped case.

Moreover, with the development of electronic communication technologies, the use of a mobile telematics system on wireless internet is rapidly increasing as well as cellular phones using voice controls. The mobile telematics system is applied to many vehicles, thus providing a convenience that various types of information may be transmitted and received within a driving vehicle. In particular, various services such as positioning information, internet and traffic information are provided via an antenna for mobile services mounted to a roof or the like of a vehicle.

FIG. 3 is an exemplary view showing a conventional antenna for mobile services. As shown in FIG. 3, the antenna for mobile services includes an antenna case 100 that has a printed circuit board (PCB) (not shown) built therein, an antenna pole 120 connected to a connector 110 of the antenna case 100, and an antenna wire 130 mounted inside the antenna pole 120. The antenna is fixed to a roof of a vehicle through the antenna case 100. In addition, the antenna wire 130 is connected to the connector 110 that is connected to the PCB to transmit or receive frequency signals.

However, when the antenna pole erected from the antenna case is broken by being bumped or hit against another object, the conventional antenna for mobile services cannot perform an antenna function for mobile services (e.g., telematics). When the antenna pole is broken as described above, i.e., when the antenna wire in the antenna pole is broken, the antenna cannot receive a mobile service such as a blue link service or emergency SOS (e-call) service.

### SUMMARY

The present invention provides a vehicle antenna for mobile services, in which a new type of antenna for mobile services that substitutes for an antenna pole in a breakdown of the antenna pole is implemented by providing a thin film type preliminary antenna that may perform antenna functions for mobile services inside an antenna case, thus, when the antenna is broken, a driver does not feel inconvenient in using mobile services.

In one aspect, the present invention provides a vehicle antenna, that may include: an antenna case having a printed circuit board (PCB) built therein; an antenna pole connected to a connector of the antenna case, and an antenna wire mounted inside the antenna pole and connected to the PCB; and a preliminary antenna mounted inside the antenna case to transmit and receive frequency signals. Thus, when the antenna pole having the antenna wire mounted therein is broken, the preliminary antenna in the antenna case may perform the functions of the antenna pole and the antenna wire.

In an exemplary embodiment, the preliminary antenna may be connected to the PCB by being connected to the connector. In addition, the preliminary antenna may be formed in the shape of a thin film forming a predetermined pattern. The preliminary antenna may include a main body that forms a predetermined pattern as one band-shaped member repetitively follows lateral and longitudinal paths in sequence, and a connection piece connected to the connector by being extended from one side of the main body.

In another exemplary embodiment, the preliminary antenna may be manufactured as a single product to be mounted inside the antenna case or to be directly printed on an inner surface of the cover of the antenna case.

The vehicle antenna for mobile services according to the present invention has advantages as follows. A separate preliminary antenna for mobile services may be provided inside an antenna case while maintaining the existing antenna mounted to a vehicle, thus, when the existing antenna is broken, antenna functions for mobile services may be continuously performed using the preliminary antenna. Thus, a driver may not feel inconvenient in using mobile services. Accordingly, it may be possible to continuously provide various conveniences related to the use of mobile services.

### BRIEF DESCRIPTION OF THE DRAWINGS

The above and other features of the present invention will now be described in detail with reference to exemplary embodiments thereof illustrated in the accompanying drawings which are given hereinbelow by way of illustration only, and thus are not limitative of the present invention, and wherein:

FIGS. 1A to 1C are exemplary views showing an antenna for mobile services according to an exemplary embodiment of the present invention;

FIG. 2 is an exemplary view showing a preliminary antenna for mobile services according to the exemplary embodiment of the present invention; and

FIG. 3 is an exemplary view showing a conventional antenna for mobile services according to the related art.

It should be understood that the accompanying drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the accompanying claims.

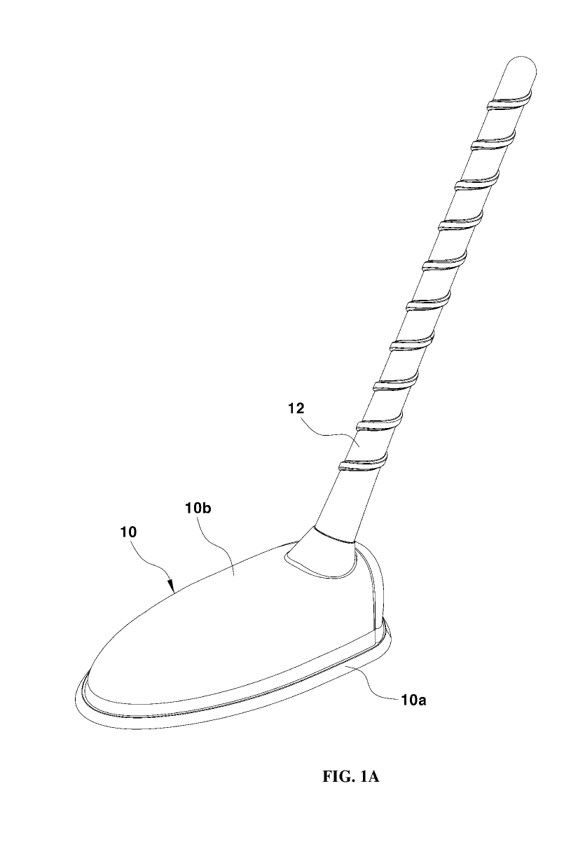

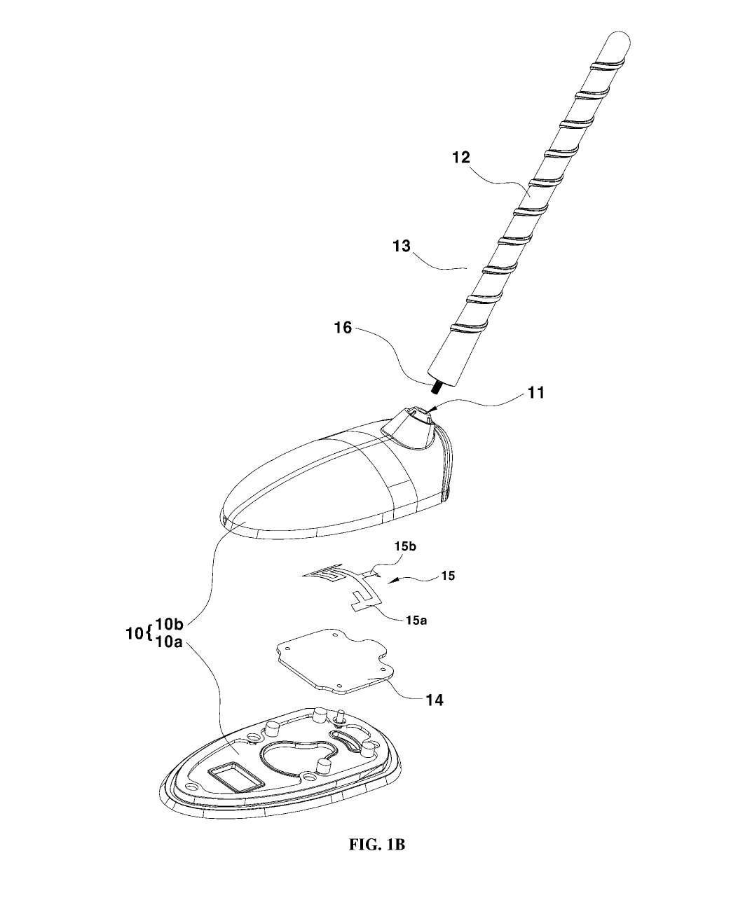

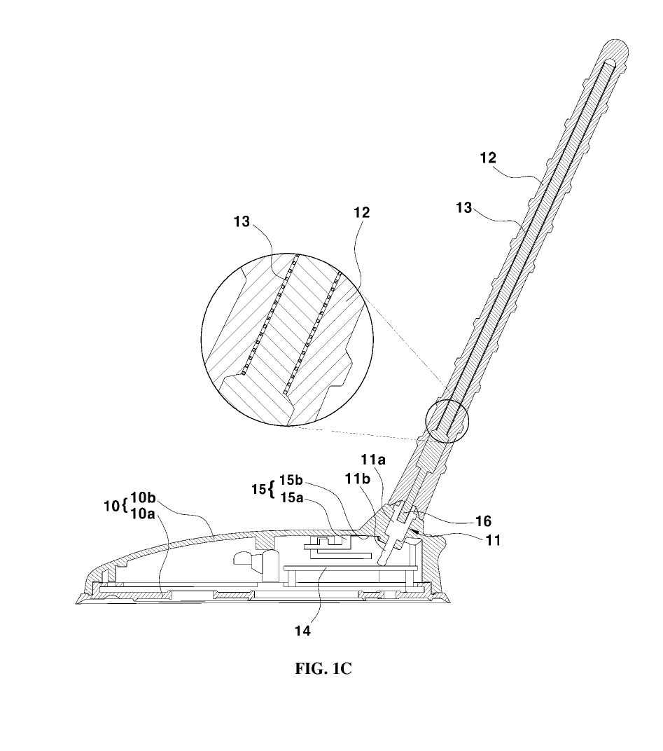

FIGS. 1A to 1C are exemplary views showing an antenna for mobile services according to an exemplary embodiment of the present invention. As shown in FIGS. 1A to 1C, the antenna for mobile services may be a pole antenna, and may have a structure that includes an antenna pole 12, an antenna wire 13 mounted inside the antenna pole 12, and a preliminary antenna 15. Thus, although the antenna pole 12 may break, the antenna for mobile services may receive mobile services using a combination of the antenna pole 12 and the antenna wire 13, and the preliminary antenna 15 that substitutes for the antenna pole 12 and the antenna wire 13.

In particular, an antenna case 10 may be mounted to a roof or the like of a vehicle. The antenna case 10 may include a base 10a and a cover 10b coupled to each other. The base 10a may be fixed to the roof or the like, and the cover 10b may provide a predetermined internal space while covering an upper portion of the base 10a. In addition, a printed circuit board (PCB) 14 may be built into the antenna case 10, and a connector 11 described later may be connected to the PCB 14. Further, the antenna wire 13 may be connected to the connector 11.

The antenna pole 12 extended upward from the antenna case 10 may be mounted at a rear end portion of the antenna case 10. In particular, the antenna pole 12 may have a rear end that is supported by the antenna case 10. For example, the antenna pole 12 may be supported by being coupled to the cover 10b of the antenna case 10. In addition, the antenna wire 13 mounted inside the antenna pole 12 may be connected to the connector 11 that is coupled to the cover 10b of the antenna case 10 by a screw fastening structure using a connecting bolt 16. In particular, the connector 11 may include a connector body 11a and a connector pin 11b. The connector body 11a may be connected to the antenna wire 13, and the connector pin 11b may be connected to the PCB 14.

Furthermore, the structure in which the entire antenna pole 12 including the antenna wire 13 is supported and connected to the antenna case 10 via the connector 11 of the antenna case 10, the structure in which the antenna wire 13 is connected to the PCB 14 via the connector 11, and the structure in which the connector 11 and the PCB 14 are connected to each other may be the same as those of the conventional antenna, and therefore, their detailed descriptions will be omitted. The PCB 14 may perform the function of a receiving circuit that includes a receiving module (not shown) for receiving frequency signals of mobile services, etc.

The pole antenna (e.g., the antenna wire) and the preliminary antenna described later may be applied to an antenna that receives frequency signals of mobile services and converts the received frequency signals into electrical control signals. Particularly, when the antenna is broken, i.e., when the antenna pole 12 and the antenna wire 13 are broken, the present invention provides the preliminary antenna 15 that substitutes for the functions of the antenna pole 12 and the antenna wire 13. In other words, when the antenna pole 12 and the antenna wire 13 do not perform their own functions due to a breakdown or the like, the present invention provides the preliminary antenna 15 which may be configured to perform antenna functions while transmitting and receiving frequency signals, in place of the antenna pole 12 and the antenna wire 13.

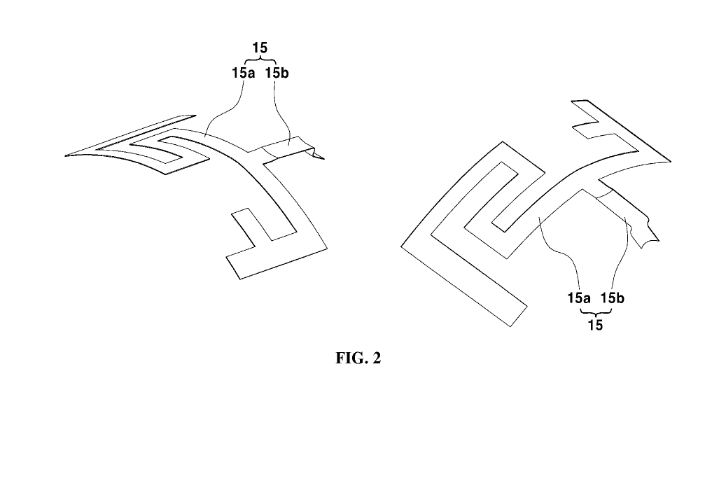

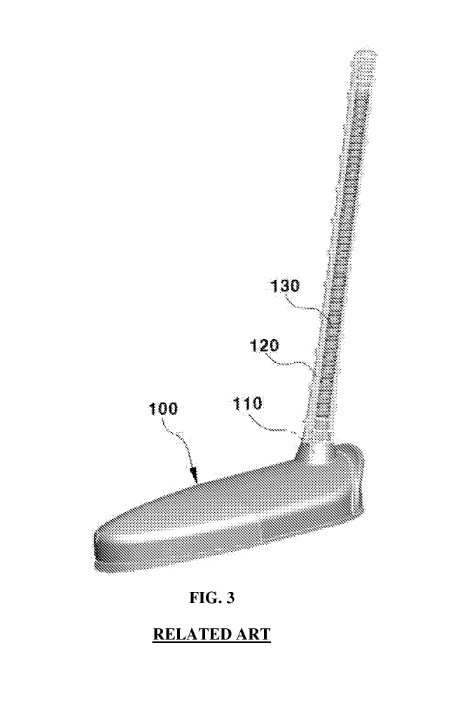

The preliminary antenna 15 may be implemented to have an antenna pattern suitable for frequencies of mobile services while having a predetermined area. In particular, the antenna pattern may be formed in various shapes according to the frequencies. As one example, the preliminary antenna 15, as shown in FIG. 2, may include a main body 15a and a connection piece 15b. The preliminary antenna 15 may have a thin film type band shape forming a predetermined pattern. As one band-shaped member repetitively follows lateral and longitudinal paths, i.e., as the one band shaped member alternately follows paths lateral and longitudinal paths in sequence, the main body 15a of the preliminary antenna 15 may form a predetermined pattern.

The connection piece 15b of the preliminary antenna 15b may be extended vertically to a predetermined length from at one side of the main body 15a of the preliminary antenna 15. In particular, the connection piece 15b of the preliminary antenna 15 may be connected to the connector 11 via an end portion thereof. Accordingly, the preliminary antenna 15 composed of the main body 15a and the connection piece 15b may be connected to the connector 11 via the connection piece 15b of the preliminary antenna 15. As a result, the connector 11 may be connected to the PCB 14, thus allowing the preliminary antenna 15 to serve as an antenna. Further, the connection structure between the preliminary antenna 15 and the PCB 14 may be variously implemented. For example, the preliminary antenna 15 may be directly connected to the PCB 14, or may be connected to the PCB 14 by the medium of the connector. Alternatively, the preliminary antenna 15 may be connected, together with the connector 11, to the PCB 14.

In the present invention, the connector 11 that has the antenna wire 13 connected thereto may be connected to the PCB 14, and the connection piece 15b of the preliminary antenna 15 may be connected to the connector 11. Particularly, the preliminary antenna 15 may be formed in the shape of a thin film layer through printing. For example, the preliminary antenna 15 may be directly printed on an inner surface of the cover 10b of the antenna case 10. In addition, the connection piece 15b of the preliminary antenna 15 may be printed to extend from the inner surface of the cover 10b to a lower surface of the connector 11 (e.g., to the connector pin 11b connected to the PCB 14).

As another example, the preliminary antenna 15 may be manufactured as a thin film band-shaped single product having a predetermined antenna pattern. In particular, the preliminary antenna 15 may be attached to the inner surface of the cover 10b of the antenna case 10. Thus, the antenna having the preliminary antenna and the pole antenna (e.g., the antenna wire), which may be mounted to the vehicle as described above, may perform antenna functions by transmitting and receiving frequency signals through each antenna. As a result, it may be possible to provide mobile services to a driver or passenger.

As described above, although the existing pole antenna may break, the antenna according to the present invention may continue to receive mobile services. Further, when the pole antenna is broken, the preliminary antenna mounted in the antenna case may perform antenna functions for mobile services, in place of the pole antenna, so that the driver does not feel inconvenient in using mobile services (e.g., telematics and the like).

The invention has been described in detail with reference to exemplary embodiments thereof. However, it will be appreciated by those skilled in the art that changes may be made in these exemplary embodiments without departing from the principles and spirit of the invention, the scope of which is defined in the accompanying claims and their equivalents.

What is claimed is:

1. A vehicle antenna, comprising:
an antenna case having a printed circuit board (PCB) built therein;
an antenna pole connected to a connector of the antenna case
an antenna wire mounted inside the antenna pole and connected to the PCB; and
a preliminary antenna mounted inside the antenna case to transmit and receive frequency signals.

2. The vehicle antenna of claim 1, wherein the preliminary antenna is connected to the PCB by being connected to the connector.

3. The vehicle antenna of claim 1, wherein the preliminary antenna is formed in the shape of a thin film forming a predetermined pattern, and the preliminary antenna includes:
a main body that forms a predetermined pattern as one band-shaped member that repetitively follows lateral and longitudinal paths in sequence; and
a connection piece connected to the connector by being extended from one side of the main body.

4. The vehicle antenna of claim 3, wherein the preliminary antenna is a single piece mounted inside the antenna case.

5. The vehicle antenna of claim 3, wherein the preliminary antenna is a single piece directly printed on an inner surface of the cover of the antenna case.
